(19) United States
(12) Patent Application Publication
(10) Pub. No.: US 2008/0079406 A1
(43) Pub. Date: Apr. 3, 2008

(54) Power supply with digital feedback loop

(76) Inventors: Gunnar R. Holmquist, Santee, CA (US); Liyu Cao, San Diego, CA (US); Daniel D. Zuck, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/541,439

(22) Filed: Sep. 28, 2006

(51) Int. Cl. G05F 1/00

(52) U.S. Cl. 323/283

(57) ABSTRACT

A power supply with digital feedback loop that is configured to generate a digital voltage error signal and a digital current error signal and to select one of the digital voltage error signal and the digital current error signal for regulating one or both of power supply output voltage and power supply output current.

### BACKGROUND OF THE INVENTION

1. Field of the Invention

The present invention relates generally to power supplies and, more particularly, to power supplies with feedback loops.

2. Description of the Related Art

Power supplies typically provide constant voltage at a preset or programmed output level to a load impedance. Since the physical output impedance of a power supply is never zero, absent a compensating scheme, the output voltage of the power supply would experience a deviation from the desired value dependent on the impedance of the load. Feedback loops are typically employed to compensate for the load-dependent output voltage.

Recently, power supplies and voltage regulators that use digital feedback loops instead of analog feedback loops have been described. See, for example, Merrill, “Digital Feedback Power Supply” (U.S. Pat. No. 5,969,514); Goodfellow, “Digitally Controlled Voltage Regulator” (U.S. Pat. No. 7,023,672). The digital feedback loop is distinguishable from the analog feedback loop in that in the former, the analog signal representing the output voltage is converted into a digital data by an analog-to-digital-converter (ADC) and at least some of the attendant signal processing associated with the feedback loop is done in the digital domain.

Although prior art power supplies with an analog or a digital feedback loop provide a constant voltage source for some applications, the flexibility is still limited.

### SUMMARY OF THE INVENTION

In one embodiment, the invention comprises a digitally controlled power supply comprising an output for connecting to a load impedance and a digital feedback loop coupled to the output. In this embodiment, the digital feedback loop comprises a voltage feedback loop configured to regulate power supply output voltage, a current feedback loop configured to regulate power supply output current, and mode switch logic configured to select one of the voltage feedback loop and current feedback loop.

In another embodiment, a digitally controlled power supply comprises a digital feedback loop comprising a voltage feedback loop configured to generate a digital voltage error signal, a current feedback loop configured to generate a digital current error signal, and a digital-to-analog-converter configured to convert one of the digital voltage error signal and the digital current error signal into an analog error signal to regulate one or both of power supply output voltage and power supply output current.

In another embodiment a method of digitally controlling a power supply is provided. The method comprises generating a digital voltage error signal, generating a digital current error signal and selecting one of the digital voltage error signal and the digital current error signal. The method further comprises generating a digital error signal, wherein the digital error signal is derived from the selected one of the digital voltage error signal and the digital current error signal. One or both of the power supply output voltage and the power supply output current is regulated with the digital error signal.

In another embodiment, a programmable power supply comprising a power output configured for connection to a load impedance, a logic circuit configured to be programmed by a user to control power supply output parameters, wherein the logic circuit is programmable to at least control the power supply output to provide a substantially constant voltage to the load impedance or a substantially constant current to the load impedance. The power supply further comprises one or more sensors coupled to the power output and configured to sense one or both an output voltage and an output current of the power supply and one or more analog to digital converters configured to digitize outputs of the one or more sensors. The power supply of this embodiment further comprises one or more digitally implemented feedback loops receiving outputs of the one or more analog to digital converters and configured to maintain one or more power supply output parameters substantially in accordance with user programmed parameters defined by the logic circuit.

### BRIEF DESCRIPTION OF THE DRAWINGS

FIG. 1 is a block diagram illustrating the power supply of the present invention.

FIG. 2 is a schematic block diagram illustrating the digital feedback loop according to an embodiment of the present invention.

FIG. 3 is a block diagram illustrating the voltage/current feedback loops of the digital feedback loop according to an embodiment of the present invention.

FIG. 4 is a block diagram illustrating output processor section of the digital feedback loop according to an embodiment of the present invention.

FIG. 5 is a schematic block diagram illustrating the mode control logic section of the digital feedback loop according to an embodiment of the present invention.

FIG. 6 is a block diagram illustrating the power hardware according to an embodiment of the present invention.

FIG. 7 is a flow diagram illustrating the method of providing the digital feedback loop of the power supply according to an embodiment of the present invention.

### DETAILED DESCRIPTION OF THE PREFERRED EMBODIMENT

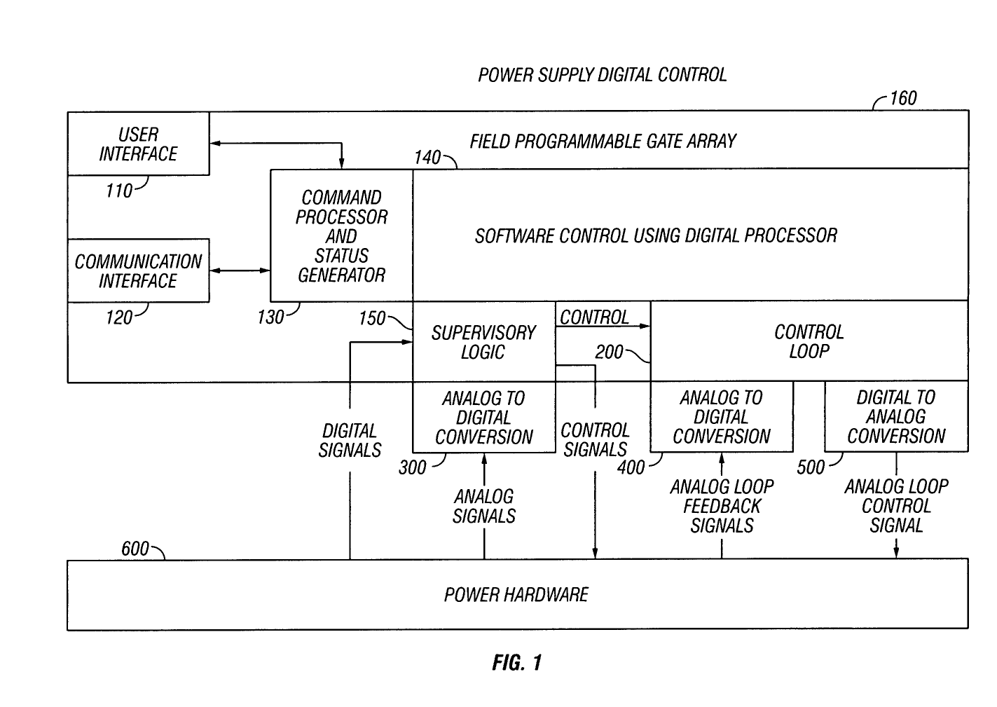

FIG. 1 is a block diagram of a power supply according to one embodiment of the invention. The power supply comprises a power supply digital control 160 and power hardware 600. The power supply digital control 160 may include a user interface 110, a communication interface 120, a command processor/status generator 130, a digital processor for running control software, supervisory logic 150, and a control loop 200, which in one exemplary embodiment may be partly or wholly implemented in a field programmable gate array. The power supply digital control further includes data converters. The data converters may include a first analog-to-digital converter (ADC) unit 300, a second ADC unit 400, and a digital-to-analog converter (DAC) unit 500.

The command processor/status generator 130 is connected to the user interface 110 and to the communication interface 120. The command processor/status generator 130 is connected to the digital processor 140 for software control. Both the supervisory logic 150 and the control loop 200 are connected to the digital processor 140. The first ADC unit 300 is connected to the supervisory logic 150, and the second ADC unit 400 and the DAC unit 500 are connected to the control loop 200.

In operation, the command process/status generator 130 receives programmable values including a reference voltage (Vref) and/or a reference current (Iref) through the user interface 110 or the communication interface 120. In a preferred embodiment, either or both of the reference voltage and the reference current may be programmed by a user. Alternatively, the reference voltage and/or the reference current may be dynamically programmed by control software that may run inside or outside the power supply digital control. The power supply digital control is configured to provide a control signal that causes the power hardware to operate at any programmed output. This is done by selectively employing digital feedback loops—a voltage feedback loop and a current feedback loop—inside the control loop 200 as will be described in more detail below. The dual feedback loops provide the power supply of this embodiment substantially full-scale adjustability of both output voltage and output current. This allows a power supply in accordance with the invention to operate as a programmable voltage source, a programmable current source, or with any other fully flexible output regulation scheme. The digital feedback for both current and voltage provides highly accurate and flexible output regulation in a programmable power supply that has not been previously obtained. In operation, the control loop 200 receives the reference voltage and the reference current and the digital feedback signals sent by the power hardware 600 and converted by the second ADC unit 400. The control loop by using one or both of the voltage feedback loop and the current feedback loop generates a digital control signal which gets converted into an analog error signal by the DAC unit 500. The power hardware 600 receives the analog control (AE) signal and its output is regulated in accordance with this signal.

FIG. 1 illustrates the digital control and processing as implemented in combinatorial and sequential logic, one example of which is a field programmable gate array, and this is one possible implementation. It will be appreciated that a wide variety of implementations are possible. The digital functions may, for example, be implemented in firmware executed by a microprocessor or digital signal processor. Discrete logic hardware may also be utilized for some or all functions. In addition, it will be appreciated that some of the functions described below can be performed in the analog domain. As used herein, the term “digital feedback loop” refers to a feedback regulation system where at least some, but not necessarily all, of the processing performed during loop operation is done with digital signal processing techniques. It is generally advantageous, however, to perform most or all of the error signal generation in the digital domain.

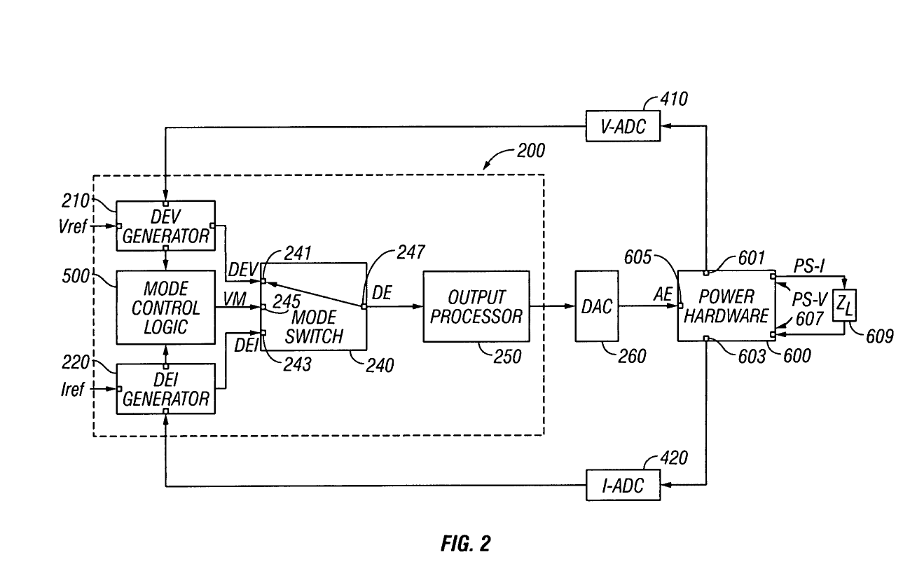

FIG. 2 is a schematic block diagram illustrating a digital feedback loop according to one embodiment of the present invention. The digital feedback loop of FIG. 2 comprises a digital voltage error (DEV) generator 210, a digital current error (DEI) generator 220, mode control logic 500, a mode switch 240 and an output processor 250. The power hardware 600 includes a voltage sensor output 601, a current sensor output 603, a control input 605 and power outputs 607. Also provided is an analog-to-digital converter for converting the voltage sensor output (V-ADC) 410 and an analog-to-digital converter for converting the current sensor output (I-ADC) 420.

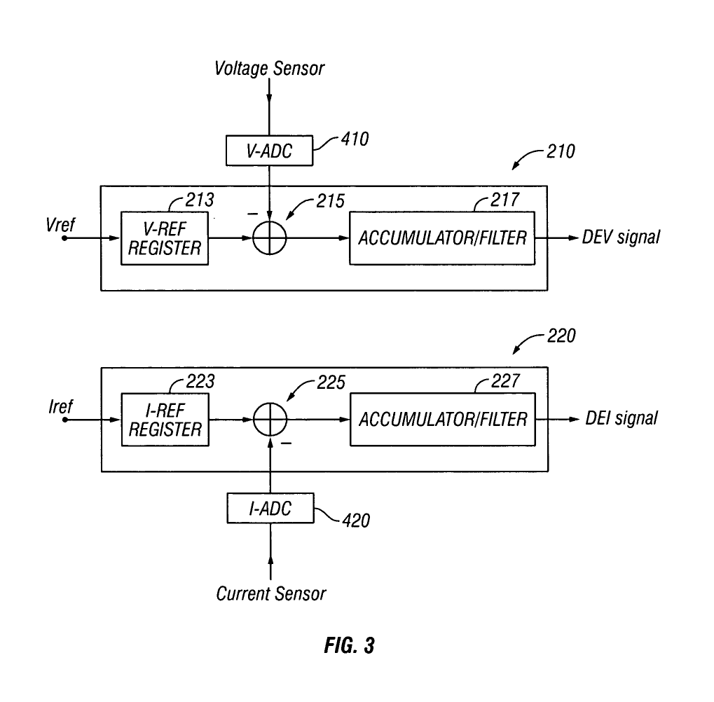

In this embodiment, the digital feedback loop comprises a voltage feedback loop and a current feedback loop. The voltage feedback loop is configured to receive an analog signal that is related to the power supply output voltage (PS-V) and to generate a digital signal that represents the difference between a reference voltage (Vref) and the output voltage. The current feedback loop is configured to receive an analog signal that is related to the power supply output current (PS-I) and to generate a digital signal that represents the difference between a reference current (Iref) and the output current. The voltage feedback loop and the current feedback loop will be described in detail below with reference to FIG. 3.

The input of the V-ADC 410 is connected to the voltage sensor output 601 of the power hardware 600. The DEV generator 210 includes a first input, a second input, and an output. The first input is connected to the output of the V-ADC 410. The second input is configured to receive a voltage reference (Vref). The input of the I-ADC 420 is connected to the current sensor output 603 of the power hardware 600. The DEI generator 220 includes a first input, a second input, and an output. The first input is connected to the output of the I-ADC 420. The second input is configured to receive a current reference (Iref).

The mode switch 240 has a first signal input 241, a second signal input 243, a control input 245, and an output 247. The first signal input 241 is connected to the output of the DEV generator 210, and the second signal input 243 is connected to the output of the DEI generator 220. The control input 245 is connected to the output of the mode control logic 500. The output 247 is connected to the input of the output processor 250. The output of the output processor 250 is connected to the input of the DAC 260. The output of the DAC 260 is connected to the control input 605 of the power hardware 600, completing the digital feedback loop. The power outputs 607 of the hardware may be connected to a load impedance 609.

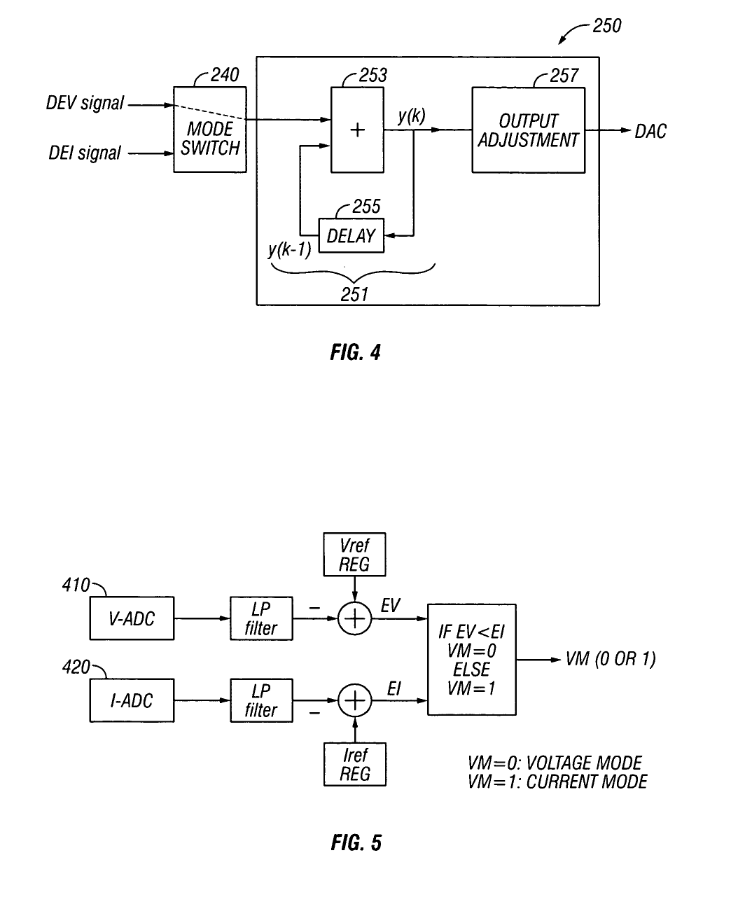

In operation, the system is usually configured to supply either a constant power supply output voltage (PS-V) or a constant power supply output current (PS-I) to the load impedance 609. The V-ADC 410 receives an analog signal representative of the PS-V from the voltage sensor output 601 of the power hardware 600 and converts it into a digital voltage signal. The DEV generator 210 receives the digital value from the V-ADC 410 and digital data representing Vref and generates a digital error voltage signal (DEV) that represents a difference between the Vref and the supply output voltage. Similarly, the I-ADC 420 receives an analog signal from the current sensor output 603 of the power hardware 600 and converts it into a digital current signal. The DEI generator 220 receives the digital value from the I-ADC 420 and digital data representing Iref and generates a digital error current signal (DEI) that represents a difference between the Iref and the power supply output current. The DEV and DEI are both received by mode switch logic 240. The mode control logic 500 generates a mode control variable (VM) that causes the mode switch 240 to select for its output one of the DEV and the DEI signals. The output processor 250 takes the mode switch logic output carrying the digital error signal and performs signal processing operations. These may include, for example, a digital integration and dc shifting, etc. The output processor 250 will be described in detail below with reference to FIG. 4. The DAC 260 takes the signal-conditioned output of the output processor 250 and converts it into an analog control (AE) signal. The power hardware 600 receives the analog control signal and regulates its power output 607.

As described above, the control loop 200 is implemented digitally, typically in a gate array and/or software controlled microprocessor architecture. It will accordingly be appreciated that although illustrated as a series of separate blocks in FIGS. 2-6, the functions performed by those blocks need not be performed by discrete or separate hardware circuits. The mode switch logic, for example, is illustrated as a physical switch, but can be implemented with any decision logic that determines whether the DEV value or DEI value is being utilized at any given time for subsequent processing in the control loop.

FIG. 3 shows a block diagram illustrating the voltage/current feedback loops of the digital feedback loop according to an embodiment of the present invention. The voltage/current feedback section includes a voltage feedback loop and a current feedback. As shown in this Figure, in preferred embodiments, the voltage feedback loop and the current feedback loop have their own accumulator/filters.

### Voltage Feedback Loop

The voltage feedback loop includes a first analog-to-digital converter (V-ADC) 410, a first subtractor 215, a V-Ref Register 213 and a first Accumulator/Filter 217. The input of the V-ADC 410 is connected to the voltage sensor output 601 of the power hardware 600, and the output of the V-ADC 410 is connected to the negative input of the first subtractor 215. The positive input of the first subtractor 215 receives the value stored in the V-Ref Register 213. The difference output of the first subtractor 215 is then received by and processed through the first Accumulator/Filter 217.

In operation, the V-ADC 410 receives the power hardware's voltage sensor output 601, which is connected to the output of a voltage sensor that is configured to sense the power supply output voltage. The V-ADC 410 digitizes the voltage sensor output and generates a digital value. The first subtractor 215 takes the Vref value and the digital output voltage value and subtracts the latter from the former. The first Accumulator/Filter 217 takes a sequence of the output values of the first subtractor 215 and performs digital filtering such as multiplying them with appropriate coefficients and adding the products to generate the digital voltage error (DEV) signal.

### Current Feedback Loop

The current feedback loop includes a second analog-to-digital converter (I-ADC) 420, a second subtractor 225, an I-Ref Register 223 and a second Accumulator/Filter 227. The input of the I-ADC 410 is connected to the current sensor output 601 of the power hardware 600, and the output of the I-ADC 410 is connected to the negative input of the second subtractor 225. The positive input of the second subtractor 225 receives the value stored in the I-Ref Register 223. The difference output of the second subtractor 225 is then received by and processed through the second Accumulator/Filter 227.

In operation, the I-ADC 420 receives the power hardware's current sensor output 603, which is connected to the output of a current sensor that is configured to sense the power supply output current. The I-ADC 420 digitizes the current sensor output and generates a digital value. The second subtractor 225 takes the Iref value and the digital output current value and subtracts the latter from the former. The second Accumulator/Filter 227 takes a sequence of the output values of the second subtractor 215 and performs digital filtering such as multiplying them with appropriate coefficients and adding the products to generate the digital current error (DEI) signal.

FIG. 4 is a block diagram illustrating the output processor section of the digital feedback loop as shown in FIG. 2 according to an embodiment of the present invention. The output processor 250 includes an integrator 251 and an output adjustment block 257, and is shared by the voltage and current feedback loops.

The shared integrator 251 has an input that is connected to the output of the mode switch 240 and an output that is connected to the input of the output adjustment block. The output of the adjustment block is connected to the input of the DAC.

In operation, the shared integrator 251 receives the digital error signal from the mode switch 240 and performs a digital integration. The digital integration includes adding a sequence of past, time-delayed digital error values to the present digital error values. The output adjustment block 257 receives the integrated digital error signal from the integrator 251 and performs output adjustment on the digital error signal to fit the value within the acceptable input range of the DAC 260. In one embodiment, the digital error signal is a signed 16-bit number in the range −2¹⁵ to 2¹⁵−1, while the DAC 260 accepts 16-bit input with the range of 0 to 2¹⁶−1. Thus, a conversion from the digital error signal to the required DAC code may be provided.

The DAC 260 receives the digital error signal that has been integrated by the shared integrator 251 and adjusted by the output adjustment block 257 and converts it into an analog control (AE) signal that is received by the control input 603 of the power hardware 600, thus completing the digital feedback loop.

FIG. 5 is a schematic block diagram illustrating the mode control logic section of the digital feedback loop as shown in FIG. 2 according to an embodiment of the present invention. In this embodiment, the voltage reference V_{ref} is subtracted from a low pass filtered measured value of the power supply output producing a value EV. The current reference I_{ref} is subtracted from a low pass filtered measured value of the power supply output current producing a value EI. These two values are compared, and if EV is less than EI, then the DEI-RMS current error is selected for further loop processing. If EV is more than or equal to EI, then the DEV-RMS voltage error is selected for further loop processing.

Typically, when the power supply is configured to provide a regulated output voltage to the load, the current reference I_{ref} is used as a current limit, and the system uses the DEV-RMS voltage error signal for further loop processing. During this operational mode, EI will be negative, and EV will fluctuate near zero. If the current exceeds I_{ref}, then EI will turn positive, exceeding EV, and the system will then select the DEI-RMS error to prevent the current from rising higher. Alternatively, the feedback could be configured to be in current mode normally, and deliver a constant current to a load, with overvoltage protection provided by the voltage feedback loop.

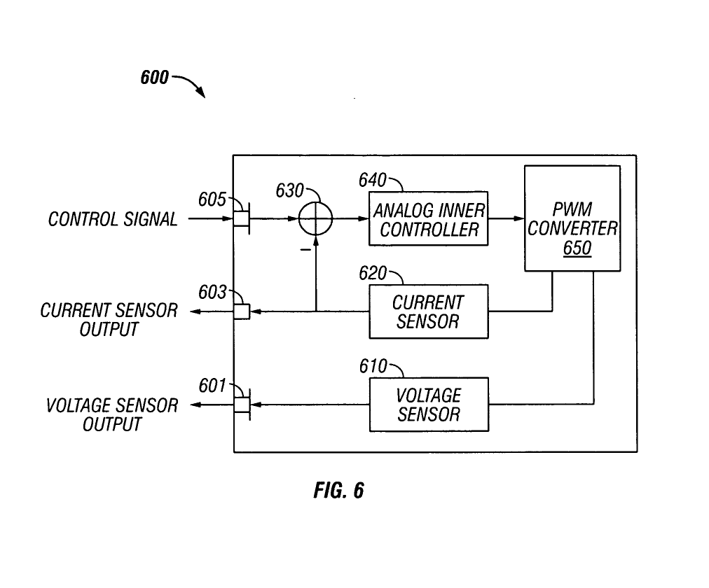

FIG. 6 is a block diagram illustrating power hardware according to one possible embodiment of the present invention. The power hardware 600 includes a pulse-width-modulation (PWM) converter 650, a voltage sensor 610, a current sensor 620, and an analog inner controller 640, and an analog subtractor 630. The power hardware 600 further includes a voltage sensor output 601, a current sensor output 603, and a control input 605.

The voltage sensor 610 is configured to sense the output voltage, and the current sensor 620 is configured to sense the output current. As shown in FIG. 2 and FIG. 3, the output of the voltage sensor 610 is connected to the input of the V-ADC 410, and the output of the current sensor 620 is connected to the input of the I-ADC 420. The output of the current sensor 620 is also connected to the negative input of the analog subtractor 630. As shown in FIG. 2, the DAC 260 receives the digital error signal from the output processor 250 and converts the digital error signal into an analog error (AE) signal. The output of the DAC is connected to the positive input of the analog subtractor 630. The output of the analog subtractor 630 is connected to the input of the analog inner controller 640. The output of the analog inner controller 640 is connected to the control the PWM converter 650.

In operation, the analog control signal generated by the DAC 260 is fed into the positive input of the analog subtractor 630 which subtracts out an analog current signal. The analog inner controller 640 receives the output from the analog subtractor 630 and utilizes the output to control the PWM converter 650 so as to regulate the power supply output.

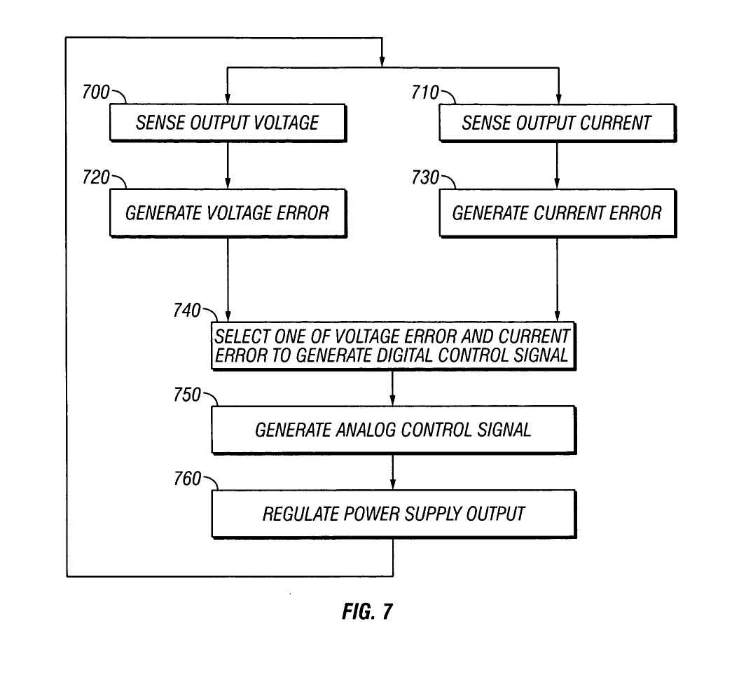

FIG. 7 is a flow diagram illustrating a method of providing a digital feedback loop according to an embodiment of the present invention. The method includes sensing the power supply output voltage at 700 and sensing the power supply output current at 710.

The method of providing a digital feedback according to one embodiment also includes generating a digital voltage error signal at 720 and generating a digital current error signal (DEI) 730.

The method further includes selecting one of the DEV and the DEI to generate a digital error signal at 740.

The method of providing a digital feedback according to one embodiment further includes generating an analog error signal at 750. The method further includes regulating a power supply output at 760.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A digitally controlled power supply comprising:
an output for connecting to a load impedance; and
a digital feedback loop coupled to said output, said digital feedback loop comprising:
a voltage feedback loop configured to regulate power supply output voltage;
a current feedback loop configured to regulate power supply output current; and
mode switch logic configured to select one of said voltage feedback loop and current feedback loop.

2. The digitally controlled power supply of claim 1, wherein:
said power supply voltage is programmable; and/or
said power supply current is programmable.

3. The digitally controlled power supply of claim 1, wherein said voltage feedback loop generates a digital voltage error signal at least in part from a difference between a power supply output voltage and a user programmed reference voltage.

4. The digitally controlled power supply of claim 1, wherein said current feedback loop generates a digital current error signal at least in part from a difference between a power supply output current and a user programmed reference current.

5. The digitally controlled power supply of claim 1, wherein said voltage feedback comprises at least one analog-to-digital-converter.

6. The digitally controlled power supply of claim 1 wherein said mode switch logic operates based on a digital voltage error signal and a digital current error signal.

7. The digitally controlled power supply of claim 1, wherein said digital feedback loops are implemented in combinatorial and sequential logic.

8. The digitally controlled power supply of claim 1, wherein said digital feedback loops are implemented in a microprocessor executing instructions stored in a memory.

9. A digitally controlled power supply comprising:
an output for connecting to a load impedance; and
a digital feedback loop coupled to said output, said digital feedback loop comprising:
a voltage feedback loop configured to generate a digital voltage error signal;
a current feedback loop configured to generate a digital current error signal; and
a digital-to-analog-converter configured to convert one of said digital voltage error signal and said digital current error signal into an analog error signal to regulate one or both of power supply output voltage and power supply output current.

10. A method of digitally controlling a power supply, said method comprising:
generating a digital voltage error signal;
generating a digital current error signal;
selecting one of the digital voltage error signal and the digital current error signal;
generating a digital error signal, wherein said digital error signal is derived from said selected one of the digital voltage error signal and the digital current error signal; and
regulating one or both of the power supply output voltage and the power supply output current with the digital error signal.

11. The method of claim 10 further comprising:
converting the digital error signal into an analog error signal.

12. The method of claim 10, wherein generating the digital voltage error signal comprises:
obtaining a reference voltage;
sensing the power supply output voltage;
converting the sensed voltage into a digital voltage value; and
subtracting the digital voltage value from the reference voltage to obtain the digital voltage error.

13. The method of claim 10, wherein generating the digital current error signal comprises:
obtaining a reference current;
sensing the power supply output current;
converting the sensed current into a digital current value; and
subtracting the digital current value from the reference current to obtain the digital current error.

14. The method of claim 10, wherein selecting one of the digital voltage error signal and the digital current error signal comprises:
producing a mode control variable from the digital voltage error and the digital current error; and
selecting one of the digital voltage error signal and the digital current error signal based at least in part on the value of the mode control variable.

15. A digitally controlled power supply comprising:
an output for connecting to a load impedance; and
a digital feedback loop coupled to said output, said digital feedback loop comprising:
a voltage sensor configured to measure the power supply output voltage;
a first analog-to-digital converter configured to generate a digital voltage value from the measured power supply output voltage;
a first digital circuit configured to generate a digital voltage error signal from said digital voltage value and a reference voltage;
a current sensor configured to measure the power supply output current;
a second analog-to-digital converter configured to generate a digital current value from the measured power supply output current;
a second digital circuit configured to generate a digital current error signal from said digital current value and a reference current;
mode switch logic configured to select one of said digital voltage error signal and said digital current error signal and to generate a digital error signal;
a digital error signal processor producing a filtered and compensated digital error signal; and
a digital-to-analog converter configured to convert said filtered and compensated digital error signal into an analog error signal for regulating one or both of said power supply output voltage and said power supply output current.

16. The power supply of claim 15 wherein at least one of said first and second digital circuits is implemented in combinatorial and sequential logic.

17. The power supply of claim 15 wherein at least one of said first and second digital circuits is implemented in a microprocessor executing instructions stored in a memory.

18. The power supply of claim 15 wherein said mode switch logic is implemented in combinatorial and sequential logic.

19. The power supply of claim 15 wherein said mode switch logic is implemented in a microprocessor executing instructions stored in a memory.

20. A programmable power supply comprising:
a power output configured for connection to a load impedance;
a logic circuit configured to be programmed by a user to control power supply output parameters, wherein said logic circuit is programmable to at least control said power supply output to provide a substantially constant voltage to said load impedance or a substantially constant current to said load impedance;
one or more sensors coupled to said power output and configured to sense one or both an output voltage and an output current of said power supply;
one or more analog to digital converters configured to digitize outputs of said one or more sensors; and
one or more digitally implemented feedback loops receiving outputs of said one or more analog to digital converters and configured to maintain one or more power supply output parameters substantially in accordance with user programmed parameters defined by said logic circuit.

21. The programmable power supply of claim 16 wherein said logic circuit is implemented in combinatorial and sequential logic.

22. The programmable power supply of claim 16 wherein said logic circuit is implemented in a microprocessor executing instructions stored in a memory.

23. A programmable power supply comprising:
a power output configured for connection to a load impedance;
means for programming a desired output voltage;
means for programming a desired output current; and
means for digitally regulating power supply output to said load impedance in accordance with at least one of said desired output voltage and desired output current.

24. The power supply of claim 23, wherein said means for digitally regulating generates a digital voltage error signal and a digital current error signal.

25. The programmable power supply of claim 23, additionally comprising means for selecting said digital voltage error signal and digital current error signal for output regulation.
